(19) United States
(12) Patent Application Publication
(10) Pub. No.: US 2013/0255044 A1
(43) Pub. Date: Oct. 3, 2013

(54) MAGNETICALLY-COUPLED FURNISHING SYSTEM

(71) Applicant: Albert CHEN, Los Angeles, CA (US)

(72) Inventor: Albert CHEN, Los Angeles, CA (US)

(21) Appl. No.: 13/434,998

(22) Filed: Mar. 30, 2012

(51) Int. Cl. F16B 12/00

(52) U.S. Cl. 24/572.1; 24/303; 24/592.1

(57) ABSTRACT

Disclosed is a furnishing system having at least furnishing and another unit of furniture, each having a plurality of faces. The furnishing has left and right first furnishing magnets of opposite polarity both disposed on a first furnishing face at a given height and spaced a given distance apart. The another unit has left and right first unit magnets of opposite polarity both disposed on a first unit face at the given height and spaced the given distance apart. The left first furnishing magnet is of the same polarity as the left first unit magnet. Positioning of the another unit relative to the furnishing such that the left first furnishing magnet magnetically couples to the right first unit magnet causes magnetic coupling of the first furnishing face to the first unit face.

### FIELD OF THE INVENTION

The present invention is generally related to furnishings. More specifically, the field of the invention as embodied in the present disclosure is related to furnishing systems having a plurality of units of furniture. Even more specifically, the field of the invention as embodied in the present disclosure is related to such systems wherein the units of furniture are adapted for disposition and temporary affixation into a plurality of relative positions, such as by magnetic fasteners.

### SUMMARY OF THE INVENTION

The invention may be embodied as a furnishing system having a plurality of units of furniture adapted for disposition and temporary affixation into a plurality of relative positions, preferably by magnetic fasteners.

While demonstrated by the specific exemplary embodiments disclosed in detail herein, the furniture units may alternatively be any combination of chairs, seats, tables, loveseats, arm rests, ottomans, footrests, and other such items. And while the fastening means may be other than magnetic, such as snaps, hook and loop, etc, the preferred magnetic fastening may be magnet-to-magnet or magnet-to-metal.

The invention may be embodied in a furnishing system having a plurality of independent units of furniture adapted for disposition and temporary affixation together into a plurality of relative positions by detachable fasteners. The units of furniture may be one or more units from the group including chairs, seats, tables, loveseats, arm rests, ottomans, and footrests. The detachable fasteners may be from the group including magnets, snaps, and hook-loop pairs. The detachable fasteners may be attracted magnet pairs. The magnet pairs may be a plurality of magnet pairs disposed on the same horizontal plane.

The plurality of magnet pairs may be disposed about a plurality of faces of at least one of the plurality of units of furniture such that the plurality of relative positions involves coupling of said plurality of faces. The plurality of magnet pairs may be disposed about a plurality of faces of a plurality of the plurality of units of furniture such that the plurality of relative positions involves coupling of said plurality of the plurality of faces.

The detachable fasteners may alternatively be magnet-steel pairs. The magnet-steel pairs may be a plurality of magnet-steel pairs disposed on the same horizontal plane. The plurality of magnet-steel pairs may be disposed about a plurality of faces of at least one of the plurality of units of furniture such that the plurality of relative positions involves coupling of said plurality of faces. The plurality of magnet-steel pairs may be disposed about a plurality of faces of a plurality of the plurality of units of furniture such that the plurality of relative positions involves coupling of said plurality of the plurality of faces.

The invention may also be embodied in a furnishing system having a furnishing and another unit of furniture, each having a plurality of faces: the furnishing having left and right first furnishing magnets of opposite polarity both disposed on a first furnishing face at a given height and spaced a given distance apart; the another unit having left and right first unit magnets of opposite polarity both disposed on a first unit face at the given height and spaced the given distance apart; wherein, the left first furnishing magnet is of the same polarity as the left first unit magnet; whereby, positioning of the another unit relative to the furnishing such that the left first furnishing magnet magnetically couples to the right first unit magnet causes magnetic coupling of the first furnishing face to the first unit face.

The furnishing may further have left and right second furnishing magnets of opposite polarity both disposed on a second furnishing face at the given height and spaced the given distance apart; wherein, the left second furnishing magnet is of the same polarity as the left first furnishing magnet; whereby, positioning of the another unit relative to the furnishing such that the left second furnishing magnet magnetically couples to the right first unit magnet causes magnetic coupling of the second furnishing face to the first unit face.

The another unit may further have left and right second unit magnets of opposite polarity both disposed on a second unit face at the given height and spaced the given distance apart; wherein, the left second unit magnet is of the same polarity as the left first unit magnet; whereby, positioning of the another unit relative to the furnishing such that the left second unit magnet magnetically couples to the right first furnishing magnet causes magnetic coupling of the first furnishing face to the second unit face.

The invention may also be embodied as a furnishing system having a furnishing and another unit of furniture, each having a plurality of faces: the furnishing having a first furnishing magnet and a first furnishing magnetically-attractive zone both disposed on a first furnishing face at a given height and spaced a given distance apart; the another unit having a first unit magnet and a first unit magnetically-attractive zone both disposed on a first unit face at the given height and spaced the given distance apart; wherein, the first furnishing magnet is identically positioned on the first furnishing face as of the first unit magnet is positioned on the first unit face, and the first furnishing magnetically-attractive zone is identically positioned on the first furnishing face as of the first unit magnetically-attractive zone is positioned on the first unit face; whereby, positioning of the another unit relative to the furnishing such that the first furnishing magnet magnetically couples to the first unit magnetically-attractive zone causes magnetic coupling of the first furnishing face to the first unit face.

The furnishing may further have a second furnishing magnet and a second furnishing magnetically-attractive zone disposed on a second furnishing face at the given height and spaced the given distance apart; wherein, the second furnishing magnet is identically positioned on the second furnishing face as of the first furnishing magnet is positioned on the first furnishing face, and the second furnishing magnetically-attractive zone is identically positioned on the second furnishing face as of the first furnishing magnetically-attractive zone is positioned on the first furnishing face; whereby, positioning of the another unit relative to the furnishing such that the second furnishing magnet magnetically couples to the first unit magnetically-attractive zone causes magnetic coupling of the second furnishing face to the first unit face.

The another unit may further have a second unit magnet and a second unit magnetically-attractive zone disposed on a second unit face at the given height and spaced the given distance apart; wherein, the second unit magnet is identically positioned on the second unit face as of the first unit magnet is positioned on the first unit face, and the second unit magnetically-attractive zone is identically positioned on the second unit face as of the first unit magnetically-attractive zone is positioned on the first unit face; whereby, positioning of the another unit relative to the furnishing such that the second unit magnet magnetically couples to the first furnishing magnetically-attractive zone causes magnetic coupling of the second unit face to the first furnishing face.

Further features and aspects of the invention are disclosed with more specificity in the Detailed Description and Drawings of an exemplary embodiment provided herein.

### BRIEF DESCRIPTION OF THE DRAWINGS

Many aspects of the invention can be better understood with reference to the following drawings showing representative embodiments described in the accompanying Detailed Description. The components in the drawings are not necessarily to scale, emphasis instead being placed upon clearly illustrating the principles of the invention. Moreover, in the drawings, like reference numerals designate corresponding parts throughout the several embodiments and views.

FIG. 1 is a perspective view of a chair for use within some embodiments of the invention;

FIG. 2 is a perspective view of two of the chairs of FIG. 1 in a forwardly-facing position according to a first embodiment of the invention;

FIG. 3 is a perspective view of the chairs of FIG. 2 magnetically-attached in a forwardly-facing configuration;

FIG. 4 is a perspective view of the chairs of FIG. 2 facing in opposite directions;

FIG. 5 is a perspective view of the chairs of FIG. 2 magnetically-attached in an oppositely-facing configuration;

FIG. 6 is a perspective view of the chairs of FIG. 2 magnetically-attached to opposite sides of a side table in a forwardly-facing configuration according to a second embodiment of the invention;

FIG. 7 is a perspective view of the chairs of FIG. 2 magnetically-attached to in a forwardly-facing configuration and further magnetically attached to the side table of FIG. 4 and to a leg rest according to a third embodiment of the invention;

FIG. 8 is a perspective view of a two-armed lounge chair in accordance with a fourth embodiment of the invention;

FIG. 9 is a perspective view of three of the two-armed lounge chairs of FIG. 8 facing in alternating directions;

FIG. 10 is a perspective view of the three two-armed lounge chairs of FIG. 9 magnetically attached in an alternating configuration;

FIG. 11 is a perspective view of a two mirror-image forwardly-facing one-armed lounge chairs in accordance with a fifth embodiment of the invention;

FIG. 12 is a perspective view of the two mirror image one-armed lounge chairs of FIG. 11 magnetically attached in a forwardly-facing configuration;

FIG. 13 is a perspective view of a two identical oppositely-facing one-armed lounge chairs in accordance with a sixth embodiment of the invention;

FIG. 14 is a perspective view of the two identical one-armed lounge chairs of FIG. 13 magnetically attached in a first oppositely-facing configuration; and

FIG. 15 is a perspective view of the two identical one-armed lounge chairs of FIG. 13 magnetically attached in a second oppositely-facing configuration.

### DETAILED DESCRIPTION OF REPRESENTATIVE EMBODIMENTS

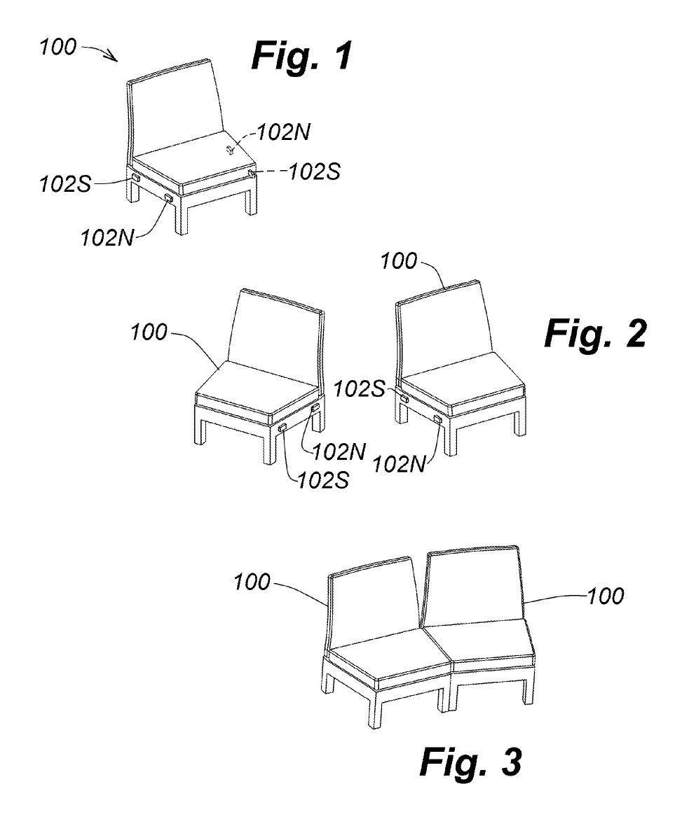

Referring first to FIG. 1, a chair 100 for use in certain embodiments of the invention is shown. The chair has two magnets, 102N and 102S, affixed to each side, four magnets in total. The 102N magnets are “north-poled” magnets and the 102S magnets are “south-poled”. The magnets are positioned such that the forwardmost magnets are both the same distance back from the front edge of the chair on each side, four inches in this case, and the rearmost magnets are both that same distance forward from the rear edge of the chair on each side, that same four inches in this case. And the magnets are spaced apart the same distance on both sides, fourteen inches in this case. All four magnets are also disposed the same distance from the floor, eighteen inches in this case. In fact the magnets are positioned on the sides of the chair such that a left side view of the chair and magnets is a substantially dimensionally perfect mirror image of a right side view.

Representative embodiments of the invention are depicted in FIGS. 2 though 15. Referring next to FIGS. 2 through 5, a first embodiment of the invention is represented by a furnishing system having a pair of the chairs 100 of FIG. 1, each substantially forwardly facing, shown in a side-by-side and separated configuration. In FIG. 3, those two chairs have been brought together such that the magnets, aligning north to south and south to north, pull the chairs together into a rigid but removable affixation. The afore-described mirror image positioning ensures that the oppositely poled magnets come into substantially perfect alignment as the chairs are brought together. This mirror image positioning also ensures that as the chairs are drawn together by the magnets, the front and rear edges of the chairs are brought into substantially perfect alignment and the chairs are held in substantially perfect and unitary vertical alignment.

It should be appreciated that the magnets not only temporarily affix the chairs together, but also substantially perfectly align the chairs at the same time, so that the user need not spend time lining up the chairs and magnets to ensure the affixed chairs are properly aligned, and so that the chairs are automatically substantially perfectly aligned in every case. In fact, it is virtually impossible to imperfectly align and affix the chairs.

The chairs can be simply separated without the use of tools by firmly prying them apart against the holding force of the magnets and separating them beyond the magnets' attractive fields.

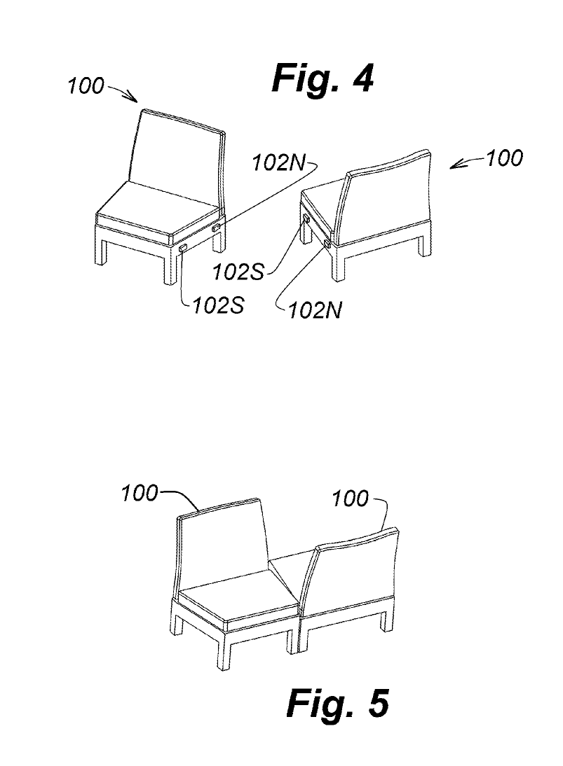

Referring next to FIG. 4, a second representative embodiment is shown having the same pair of chairs 100, facing in relatively opposite directions. In FIG. 5 those two chairs have been brought together such that the magnets, aligning north to south and south to north, pull the chairs together into a rigid but removable oppositely-facing affixation. The afore-described magnet positioning ensures again that the oppositely poled magnets come into substantially perfect alignment as the chairs are brought together. This positioning also ensures again that as the chairs are drawn together by the magnets, the front and rear edges of the chairs are again brought into substantially perfect alignment and the chairs are again held in substantially perfect and unitary vertical alignment.

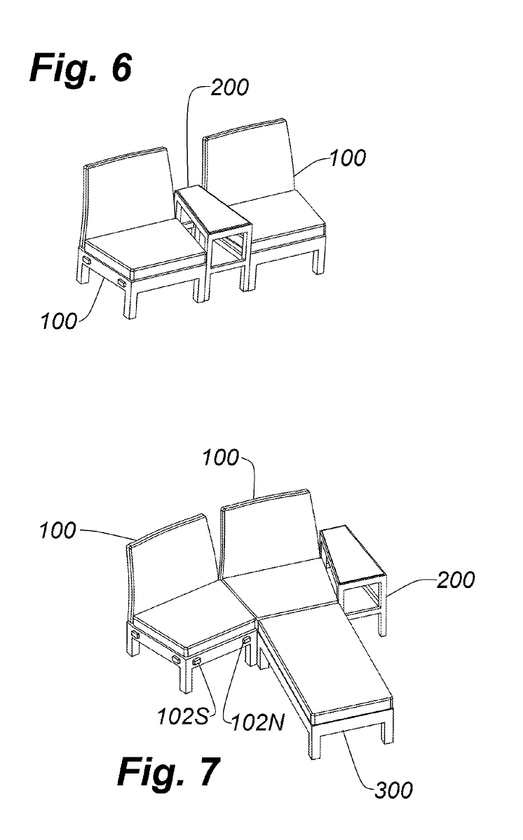

Referring next to FIG. 6 a second representative embodiment is shown having the same pair of chairs 100, attached to and through a side table 200. The side table has four magnets (not seen) in identical positioning as the chairs, with the same poles and dimensional arrangement. It should be appreciated that either of the chairs can be turned around relative to the remainder of the assembly to form a front-and-back arrangement, of that the tapered table may be turned around to change the angular relationship of the chairs.

As shown in FIG. 6, the chairs are relatively disposed at an obtuse angle, but if the table was rotated front-to-back, the chairs would be relatively disposed at an acute angle.

FIG. 7 shows a third embodiment having the chairs 100 and that side table 200 of the second embodiment, plus a leg rest 300. In this case, additional magnet pairs are positioned in the front face of the chair and the rear face of the leg rest. The leg rest may be magnetically attached to the rightmost chair as shown, or simply moved into attachment with the leftmost chair.

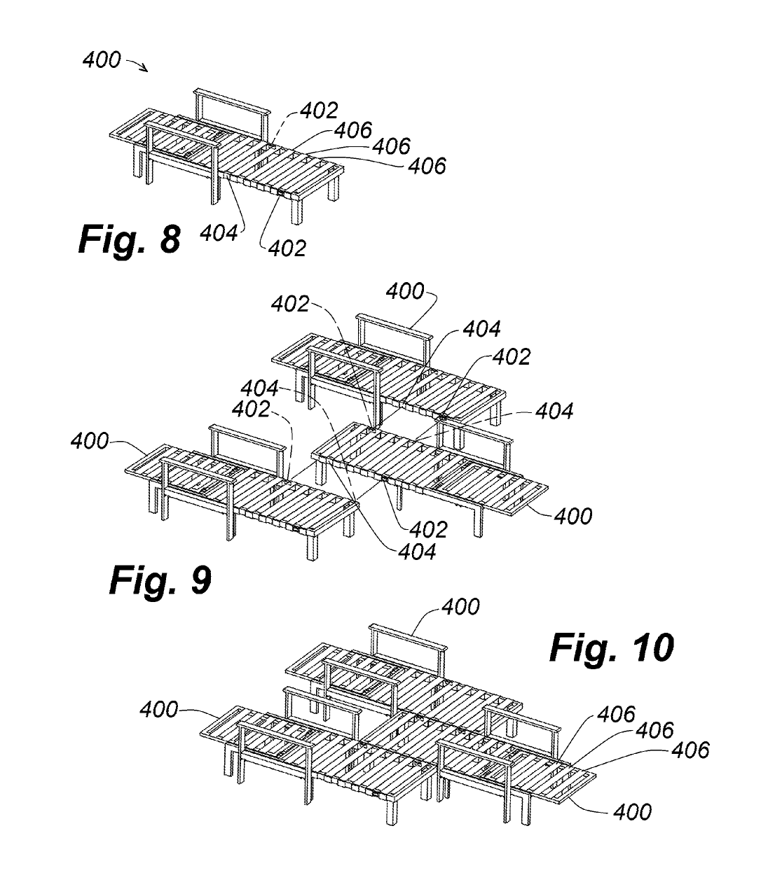

FIG. 8 shows a two-armed lounge chair 400 for use in certain other embodiments of the invention. The chair has a steel frame 404, which of course is attracted to and by certain magnetic forces. Permanently affixed to each side of the chair is one magnet 402, two magnets in total. The magnets on each side are disposed at the same height from the floor, but are each disposed at differing distances back from the front edge of the chair.

Wrapped around the steel frame is a plurality of equally-spaced flexible slats 406. The slats serve two useful purposes; they provide comfortable and flexible support to the user, and they create equally-spaced voids there-between along the sides of the chair's steel frame.

FIGS. 9 and 10 depict a system according to a fourth representative embodiment using three of two-armed lounge chairs 400 of FIG. 8. In FIG. 9, the chairs are spaced apart and alternately positioned; forwardly, rearwardly, and forwardly. In FIG. 10, the chairs are brought together such that each magnet and the steel frame of the adjacent chair are pulled together into a rigid but removable affixation.

The equally-spaced voids along the sides of the steel frames expose the steel frames to the magnet of the adjacent chair so that the chairs may be rearranged in numerous relative forward-to-backward side-by-side relationships.

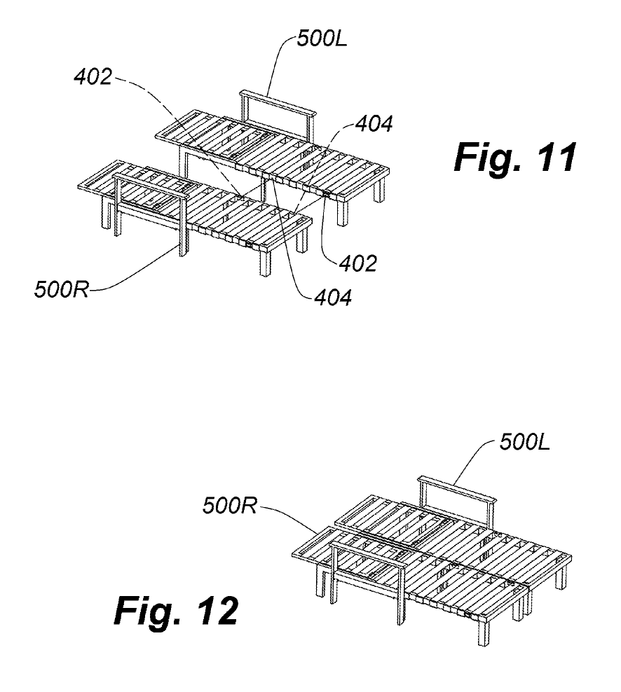

FIG. 11 shows a pair of mirror image oppositely-one-armed lounge chairs 500L and 500R for use in certain other embodiments of the invention. Other than having only one arm each, these chairs are otherwise identical to the chairs 400 of the previous embodiment. In FIG. 12, the chairs are temporarily magnetically affixed in a side-by-side arrangement. As in the previous embodiment, the equally-spaced voids between slats along the sides of the steel frames expose the steel frames to the magnet of the adjacent chair so that the chairs may be rearranged in numerous relative forward-to-backward side-by-side relationships.

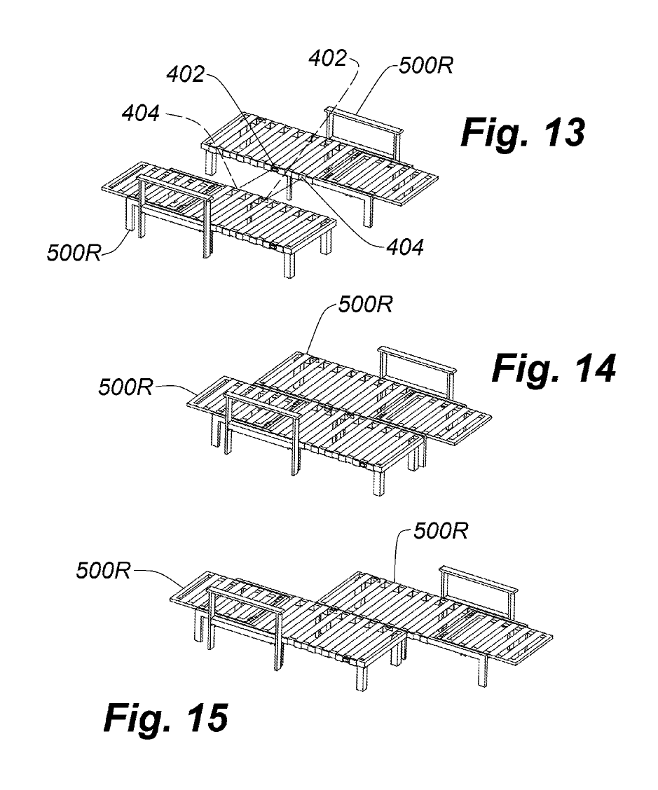

FIG. 13 shows a pair of the one-armed lounge chairs of the previous embodiment. In FIG. 14, the chairs are temporarily magnetically affixed in a side-by-side oppositely-facing arrangement. As in the previous embodiment, the equally-spaced voids between slats along the sides of the steel frames expose the steel frames to the magnet of the adjacent chair so that the chairs may be rearranged in numerous relative forward-to-backward side-by-side relationships, as demonstrated by FIG. 15.

Alternative embodiments of the furniture units of the various embodiments may have one magnet positioned near to each corner of the unit such that it becomes aligned with either a steel surface of the adjacent unit or with an oppositely-poled magnet on the adjacent unit as the two units are brought together. Where oppositely-poled magnets are employed, the magnets on diagonally opposite corners of the unit are of opposite polarity, to allow the units to be coupled either facing the same way or in differing directions

Using the principle that magnetic forces are the strongest in the center of the magnet, the magnetic coupling systems shown cause any two coupled units to auto-align into a flush arrangement.

Where a magnet-to-steel coupling is employed, a steel area is always disposed on the first unit in the place where a magnet of the adjacent unit will contact the first unit, and a magnet is always disposed on the first unit in the place where the mating steel area of the adjacent unit will contact the first unit.

In those embodiments employing magnet-to-steel couplings, the steel frame could alternatively be any material having a steel or iron plate affixed thereon in the coupling location, or could be a material impregnated with steel fibers or particles to make it magnetically attractive.

While the invention has been shown and described with reference to the above-described representative embodiments, it should be understood by those skilled in the art that various changes may be made thereto without sacrificing its material advantages. Various changes in form and detail may be made without departing from the spirit and scope of the invention, and the invention should therefore only be limited according to the following claims, including all equivalent interpretation to which they are entitled.

I claim:

1. A furnishing system comprising a plurality of independent units of furniture adapted for disposition and temporary affixation together into a plurality of relative positions by detachable fasteners.

2. The furnishing system of claim 1 wherein the units of furniture comprise one or more units from the group including chairs, seats, tables, loveseats, arm rests, ottomans, and footrests.

3. The furnishing system of claim 2 wherein the detachable fasteners are from the group including magnets, snaps, and hook-loop pairs.

4. The furnishing system of claim 3 wherein the detachable fasteners are attracted magnet pairs.

5. The furnishing system of claim 4 wherein the magnet pairs are a plurality of magnet pairs disposed on the same horizontal plane.

6. The furnishing system of claim 5 wherein the plurality of magnet pairs are disposed about a plurality of faces of at least one of the plurality of units of furniture such that the plurality of relative positions comprises coupling of said plurality of faces.

7. The furnishing system of claim 6 wherein the plurality of magnet pairs are disposed about a plurality of faces of a plurality of the plurality of units of furniture such that the plurality of relative positions comprises coupling of said plurality of the plurality of faces.

8. The furnishing system of claim 3 wherein the detachable fasteners are magnet-steel pairs.

9. The furnishing system of claim 8 wherein the magnet-steel pairs are a plurality of magnet-steel pairs disposed on the same horizontal plane.

10. The furnishing system of claim 9 wherein the plurality of magnet-steel pairs are disposed about a plurality of faces of at least one of the plurality of units of furniture such that the plurality of relative positions comprises coupling of said plurality of faces.

11. The furnishing system of claim 10 wherein the plurality of magnet-steel pairs are disposed about a plurality of faces of a plurality of the plurality of units of furniture such that the plurality of relative positions comprises coupling of said plurality of the plurality of faces.

12. A furnishing system comprising a furnishing and another unit of furniture, each having a plurality of faces:
the first furnishing comprising left and right first furnishing magnets of opposite polarity both disposed on a first furnishing face at a given height and spaced a given distance apart;
the another unit comprising left and right first unit magnets of opposite polarity both disposed on a first unit face at the given height and spaced the given distance apart;
wherein, the left first furnishing magnet is of the same polarity as the left first unit magnet; whereby, positioning of the another unit relative to the furnishing such that the left first furnishing magnet magnetically couples to the right first unit magnet causes magnetic coupling of the first furnishing face to the first unit face.

13. The furnishing system of claim 12 wherein the furnishing further comprises left and right second furnishing magnets of opposite polarity both disposed on a second furnishing face at the given height and spaced the given distance apart;
wherein, the left second furnishing magnet is of the same polarity as the left first furnishing magnet; whereby, positioning of the another unit relative to the furnishing such that the left second furnishing magnet magnetically couples to the right first unit magnet causes magnetic coupling of the second furnishing face to the first unit face.

14. The furnishing system of claim 12 wherein the another unit further comprises left and right second unit magnets of opposite polarity both disposed on a second unit face at the given height and spaced the given distance apart;
wherein, the left second unit magnet is of the same polarity as the left first unit magnet; whereby, positioning of the another unit relative to the furnishing such that the left second unit magnet magnetically couples to the right first furnishing magnet causes magnetic coupling of the first furnishing face to the second unit face.

15. The furnishing system of claim 14 wherein the furnishing further comprises left and right second furnishing magnets of opposite polarity both disposed on a second furnishing face at the given height and spaced the given distance apart;
wherein, the left second furnishing magnet is of the same polarity as the left first furnishing magnet; whereby, positioning of the another unit relative to the furnishing such that the left second furnishing magnet magnetically couples to the right first unit magnet causes magnetic coupling of the second furnishing face to the first unit face.

16. A furnishing system comprising a furnishing and another unit of furniture, each having a plurality of faces:
the furnishing comprising a first furnishing magnet and a first furnishing magnetically-attractive zone both disposed on a first furnishing face at a given height and spaced a given distance apart;
the another unit comprising a first unit magnet and a first unit magnetically-attractive zone both disposed on a first unit face at the given height and spaced the given distance apart; wherein, the first furnishing magnet is identically positioned on the first furnishing face as of the first unit magnet is positioned on the first unit face, and the first furnishing magnetically-attractive zone is identically positioned on the first furnishing face as of the first unit magnetically-attractive zone is positioned on the first unit face; whereby, positioning of the another unit relative to the furnishing such that the first furnishing magnet magnetically couples to the first unit magnetically-attractive zone causes magnetic coupling of the first furnishing face to the first unit face.

17. The furnishing system of claim 16 wherein the furnishing further comprises a second furnishing magnet and a second furnishing magnetically-attractive zone disposed on a second furnishing face at the given height and spaced the given distance apart;
wherein, the second furnishing magnet is identically positioned on the second furnishing face as of the first furnishing magnet is positioned on the first furnishing face, and the second furnishing magnetically-attractive zone is identically positioned on the second furnishing face as of the first furnishing magnetically-attractive zone is positioned on the first furnishing face; whereby, positioning of the another unit relative to the furnishing such that the second furnishing magnet magnetically couples to the first unit magnetically-attractive zone causes magnetic coupling of the second furnishing face to the first unit face.

18. The furnishing system of claim 16 wherein the another unit further comprises a second unit magnet and a second unit magnetically-attractive zone disposed on a second unit face at the given height and spaced the given distance apart;
wherein, the second unit magnet is identically positioned on the second unit face as of the first unit magnet is positioned on the first unit face, and the second unit magnetically-attractive zone is identically positioned on the second unit face as of the first unit magnetically-attractive zone is positioned on the first unit face; whereby, positioning of the another unit relative to the furnishing such that the second unit magnet magnetically couples to the first furnishing magnetically-attractive zone causes magnetic coupling of the second unit face to the first furnishing face.

19. The furnishing system of claim 18 wherein the furnishing further comprises a second furnishing magnet and a second furnishing magnetically-attractive zone disposed on a second furnishing face at the given height and spaced the given distance apart;
wherein, the second furnishing magnet is identically positioned on the second furnishing face as of the first furnishing magnet is positioned on the first furnishing face, and the second furnishing magnetically-attractive zone is identically positioned on the second furnishing face as of the first furnishing magnetically-attractive zone is positioned on the first furnishing face; whereby, positioning of the another unit relative to the furnishing such that the second furnishing magnet magnetically couples to the first unit magnetically-attractive zone causes magnetic coupling of the second furnishing face to the first unit face.

20. The furnishing system of claim 19 wherein the furnishing comprises one from the group including chairs, seats, tables, loveseats, arm rests, ottomans, and footrests, and the another unit of furniture comprises a different one from the group including chairs, seats, tables, loveseats, arm rests, ottomans, and footrests.
